(19) United States
(12) Patent Application Publication
(10) Pub. No.: US 2014/0375159 A1
(43) Pub. Date: Dec. 25, 2014

(54) ROLLER DEVICE FOR A TRACTION MECHANISM DRIVE OF A MOTOR VEHICLE

(71) Applicant: SCHAEFFLER TECHNOLOGIES GMBH & CO. KG, Herzogenaurach (DE)

(72) Inventors: Oliver Dippold, Forchheim (DE); Ralf Wagner, Obermichelbach (DE)

(73) Assignee: SCHAEFFLER TECHNOLOGIES GMBH & CO. KG, Herzogenaurach (DE)

(21) Appl. No.: 14/280,931

(22) Filed: May 19, 2014

(30) Foreign Application Priority Data
Jun. 24, 2013 (DE) 102013211919.4

(51) Int. Cl. H02K 49/10; H02K 49/04

(52) U.S. Cl. CPC H02K 49/104; H02K 49/04
USPC 310/95; 310/105

(57) ABSTRACT

A roller device for a traction mechanism drive, with a roller element for introducing a torque provided via the traction mechanism and a driven shaft for driving an auxiliary unit of a motor vehicle. The roller device further has a magnetic coupling for torque transfer between the roller element and the driven shaft. The magnetic coupling has a primary-side unit connected to the roller element having a primary magnetic element and a secondary-side unit connected to the driven shaft with a secondary-side magnetic element. The magnetic elements are permanent and/or electromagnetic elements and the torque transfer is realized by magnetic fields of the primary and secondary-side magnetic elements. At least one magnetic element of the two units for changing the magnetic field overlap of the magnetic fields of the primary and secondary-side magnetic elements is arranged movably within its unit by the centrifugal forces occurring during operation.

### INCORPORATION BY REFERENCE

The following documents are incorporated herein by reference as if fully set forth: German Patent Application No. 102013211919.4, filed Jun. 24, 2013.

### FIELD OF THE INVENTION

The invention relates to a roller device for a traction mechanism drive of a motor vehicle, with a roller element for introducing a torque provided via the traction mechanism of the traction mechanism drive and a driven shaft for driving an auxiliary unit of the motor vehicle.

From the document DE 101 48 961 A1, a traction mechanism drive formed as a belt drive is known with a roller element formed as an input belt pulley for driving auxiliary units, wherein this drive is connected via a planetary drive to a crankshaft of the internal combustion engine, wherein different auxiliary units can be driven by output belt pulleys via the traction mechanism driven by the belt pulley. In addition, through the use of another output belt pulley, an electric machine is also connected to the traction mechanism, in order to generate, in the generator mode, electrical energy from the mechanical energy of the traction mechanism or to be able to provide additional torque to the traction mechanism in the motor mode.

### SUMMARY

The object of the invention is to provide measures that allow a variable and safe drive of auxiliary units via a traction mechanism drive.

This objective is met by a roller device, a traction mechanism drive, and also by a method for driving an auxiliary unit connected via a roller device with one or more features of the invention. Preferred constructions of the invention are disclosed below and in the claims.

According to the invention, a roller device for a traction mechanism drive of a motor vehicle is provided that has the following components: (a) a roller element for introducing a torque provided by the traction mechanism of the traction mechanism drive, (b) a driven shaft for driving an auxiliary unit of the motor vehicle, (c) a magnetic coupling for the torque transfer between the roller element and the driven shaft, wherein the magnetic coupling has a primary-side unit connected to the roller element with at least one primary magnetic element and a secondary-side unit connected to the driven shaft with at least one secondary-side magnetic element. The magnetic elements are permanent magnet and/or electromagnetic elements. The torque is transferred via the magnetic fields of the primary-side and secondary-side magnetic elements, wherein at least one magnetic element of the two units is arranged so that it is displaceable within its unit by centrifugal forces occurring during operation for changing the magnetic field overlap of the magnetic fields of the primary-side and secondary-side magnetic elements. Due to the centrifugal forces occurring during operation, the displaceability of the at least one magnetic element produces a self-setting (control) system for transferring torque. This torque transfer can also be called a non-positive torque transfer, wherein the term non-positive—which is different from the typical use in the term “non-positive connection”—is not synonymous with the term frictional engagement. For displacing the at least one displaceable magnetic element, no actuators are necessary and also does not require control from the outside.

Advantageously all of the magnetic elements of at least one of the two units for changing the magnetic field overlap of the magnetic fields of the primary-side and secondary-side magnetic elements are arranged so that they can be displaced within their unit.

In general it is naturally possible that the at least one displaceably arranged magnetic element can be displaced by separate centrifugal force masses and a corresponding lever system. In particular, however, it is provided that the at least one magnetic element arranged so that it can be displaced by centrifugal forces occurring during operation can be displaced by the centrifugal force acting on this magnetic element itself during operation.

According to one preferred embodiment of the invention it is provided that the displaceability of the at least one magnetic element has a radial displaceability or has at least a radial component.

According to another preferred embodiment of the invention, the at least one displaceable magnetic element is a permanent magnetic element. Alternatively it is provided that the at least one displaceable magnetic element is an electromagnetic element.

In one preferred construction of the invention, the roller device has at least one restoring element that counteracts the centrifugal force for displacing the at least one displaceable magnetic element. In particular, this at least one restoring element is part of the unit that also has the at least one displaceable magnetic element.

Here it is provided, in particular, that the at least one restoring element is constructed as a spring device. The spring device has, in particular, a compression spring.

Advantageously the magnetic coupling is constructed as an eddy current coupling. Such a magnetic coupling can have an especially simple and robust construction.

The invention further relates to a traction mechanism drive for driving auxiliary units of a motor vehicle with an input roller element that can be connected to an engine shaft, in particular, crankshaft, of a motor vehicle engine, at least one output roller device coupled to the input roller element via a common traction mechanism for driving the associated auxiliary unit, in particular, a water pump, wherein at least one output roller device is constructed as a roller device that can be constructed and improved as described above. In other words, the invention relates to a use of the roller device named above in a traction mechanism drive of a motor vehicle for the purpose of outputting a portion of a torque provided by a motor vehicle engine for driving the motor vehicle to an auxiliary unit. Advantageously, in the traction mechanism drive there are several output roller devices, wherein, in particular, several, advantageously all of the output roller devices are constructed as the roller device described above.

The invention further relates to a method for driving an auxiliary unit connected via a roller device described above in a motor vehicle, in which the control and/or regulation of a nominal rotational speed of the driven shaft of the roller device is realized by a displacement of the at least one displaceable magnetic element. The rotational speed is regulated according to the principle of a centrifugal force regulator. The method can be realized and improved, in particular, as explained above with reference to the roller device.

### BRIEF DESCRIPTION FO THE SEVERAL VIEWS OF THE DRAWINGS

The invention is explained below using examples with reference to the accompanying drawings, wherein the features described below can be aspects of the invention both individually and also in combination. Shown are:

FIG. 1: a schematic sectional view of a roller device with a magnetic coupling according to a preferred embodiment of the invention, and

FIG. 2: a schematic diagram of the magnetic coupling shown in FIG. 1 from a different perspective.

### DETAILED DESCRIPTION OF THE PREFERRED EMBODIMENTS

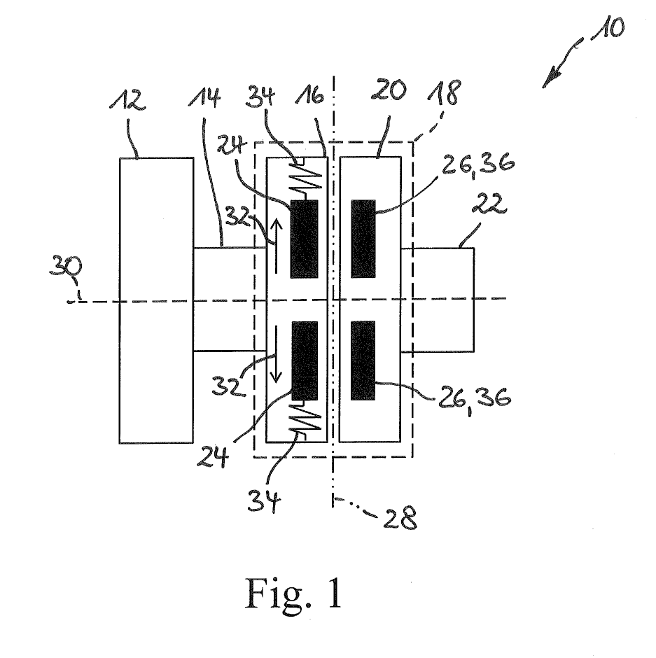

FIG. 1 shows a roller device 10 for a traction mechanism drive of a motor vehicle in a schematic sectional view. The roller device 10 has, on the input side, a roller element 12 for introducing a torque provided via the (not shown) traction mechanism of the traction mechanism drive. The traction mechanism can be, for example, a belt, chain, etc. The roller element 12 is connected locked in rotation via an input shaft 14 with a primary-side unit 16 of a magnetic coupling 18. A secondary-side unit 20 of the magnetic coupling 18 is connected on the output side locked in rotation with a driven shaft 22 of the roller device 10. The magnetic coupling 18 is thus a coupling for non-positive torque transfer between the roller element 12 and the driven shaft 22. The driven shaft 22 is a driven shaft 22 for driving a (not shown) auxiliary unit of the motor vehicle.

In each of the two units 16, 20 of the magnetic coupling 18 there is at least one magnetic element 24, 26. In the schematic diagram of FIG. 1 there are two primary magnetic elements 24 of the primary unit 16 and a secondary magnetic element 26 of the secondary unit 20. The non-positive torque transfer is realized (at least in normal mode) via the magnetic fields of the primary-side and secondary-side magnetic elements 24, 26. The two units 16, 20 of the magnetic coupling 18 are supported so that they can rotate opposite each other within the roller device 10 and bring the primary magnetic elements 24 opposite the secondary magnetic elements 26 with respect to a plane 28 perpendicular to a common axis 30 of the shafts 14, 22.

While the secondary magnetic elements 26 are arranged fixed within their unit 20, the primary magnetic elements 24 are arranged so that they are displaceable within their unit 16 for changing the magnetic field overlap of the magnetic fields of the primary-side and secondary-side magnetic elements 24, 26 within their unit 16 (arrows 32). More precisely, these displaceable magnetic elements 24 are arranged so that they are displaceable in the radial direction within their unit 16. The displacement of the displaceable magnetic field elements leads to a change in the magnetic field overlap of the magnetic fields of the primary-side and secondary-side magnetic elements 24, 26. This causes a change in the transmitted torque. The displacement of the displaceable magnetic elements (here the primary magnetic elements 24) can vary the ratio of the rotational speed ω2 of the driven shaft 22 and that of the auxiliary unit connected to this driven shaft relative to the rotational speed ω1 of the roller element 12 specified by the traction mechanism drive according to the principle of a centrifugal force regulator.

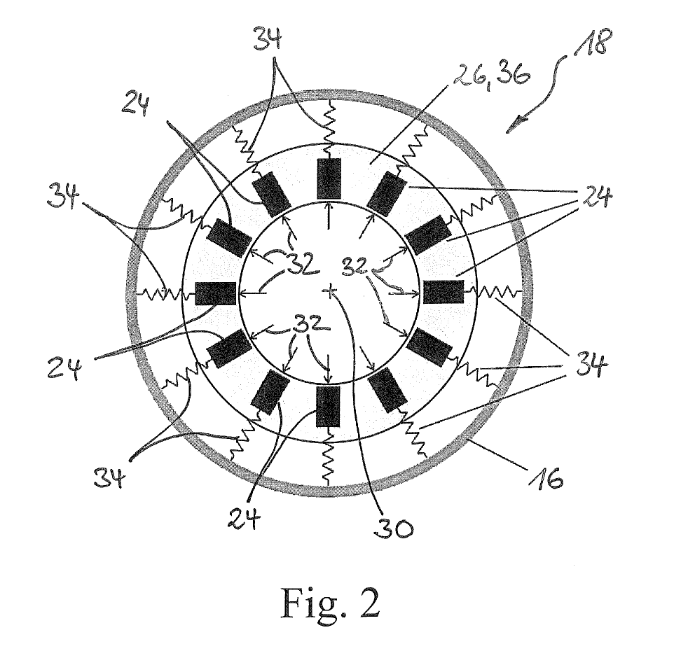

In FIG. 2 it can be seen that the single secondary magnetic element 26 is constructed as an electromagnetic element, more specifically, as a single, closed, ring-shaped conductor loop 36.

The switching state shown in FIG. 2 for the coupling 18 is ON. This means a maximum field entrainment (eddy current) of the secondary magnetic element 26 of the secondary unit 20 by the primary magnetic elements 24 of the primary unit 16.

In the (not shown) switching state OFF of the magnetic coupling 18, the magnetic elements 24 are at the maximum deflection by the mechanism shown in FIGS. 1 and 2 and there is a minimum overlap between the magnetic fields of the primary and secondary magnetic elements 24, 26.

For all of the variants it is applicable that the primary and secondary units 16, 20 can be exchanged. Likewise, the adjustment mechanism described in FIG. 2 can be inverted, i.e., the left or right extreme position can be achieved by means of the restoring element 34 or the actuator device.

The restoring element 34 can be any kind of mechanical (force/energy) accumulator, e.g., spring, helical spring, compression spring, tension spring, spiral spring, torsion spring, wrap spring, viscous spring, gas compression spring, air spring, elastomer spring, leaf spring, plate spring, torsion bar spring, cylindrical helical spring, conical helical spring, coil spring. Likewise, the (force/energy) accumulator can also have an electric, magnetic, electrostatic, pneumatic, hydraulic, thermal, or chemical construction.

### LIST OF REFERENCE NUMBERS

10 Roller device

12 Roller element

14 Input shaft

16 Primary-side unit

18 Magnetic coupling

20 Secondary-side unit

22 Driven shaft

24 Primary magnetic element

26 Secondary magnetic element

28 Plane

30 Axis

32 Double arrow

34 Restoring element

36 Conductor loop

1. A roller device for a traction mechanism drive of a motor vehicle, comprising
a roller element for introducing a torque provided by the traction mechanism of the traction mechanism drive,
a driven shaft for driving an auxiliary unit of the motor vehicle, and
a magnetic coupling for torque transfer between the roller element and the driven shaft,
wherein the magnetic coupling includes a primary-side unit connected to the roller element with at least one primary-side magnetic element and a secondary-side unit connected to the driven shaft with at least one secondary-side magnetic element, the magnetic elements are at least one of permanent magnetic or electromagnetic elements and the torque transfer is realized by magnetic fields of the primary-side and secondary-side magnetic elements, at least one of the magnetic elements of the primary-side or secondary side units is arranged displaceably within the respective unit for movement by centrifugal forces occurring during operation for changing a magnetic field overlap of the magnetic fields of the primary-side and secondary-side magnetic elements.

2. The roller device according to claim 1, wherein the at least one magnetic element arranged displaceably for movement by centrifugal forces occurring during operation is displaceable by the centrifugal force acting on the magnetic element itself during operation.

3. The roller device according to claim 1, wherein the displaceability of the at least one displaceable magnetic element is in a radial direction or a direction having at least a radial component.

4. The roller device according to claim 1, wherein the at least one displaceable magnetic element is a permanent magnetic element.

5. The roller device according to claim 1, wherein the at least one displaceable magnetic element is an electromagnetic element.

6. The roller device according to claim 1, further comprising at least one restoring element that acts against the centrifugal force for displacing the at least one displaceable magnetic element.

7. The roller device according to claim 6, wherein the at least one restoring element is a spring device.

8. The roller device according to claim 1, wherein the magnetic coupling is formed as an eddy current coupling.

9. A traction mechanism drive for driving auxiliary units of a motor vehicle with an input roller element that is connectable to an engine shaft of a motor vehicle engine, at least one output roller device coupled via a common traction mechanism to the input roller element for driving the associated auxiliary unit, wherein the output roller device or at least one of the output roller devices is constructed as a roller device according to claim 1.

10. A method for driving an auxiliary unit of a motor vehicle connected via a roller device according to claim 1, the method comprising controlling and/or regulating a rotational speed of the driven shaft of the roller device by displacing the at least one displaceable magnetic element of the magnetic coupling of the roller device .
